(19) United States
(12) Patent Application Publication
(10) Pub. No.: US 2025/0262813 A1
(43) Pub. Date: Aug. 21, 2025

(54) 3D PRINTED FURNITURE AND METHOD OF MAKING THE SAME

(71) Applicant: Haddy, Inc., St. Petersburg, FL (US)

(72) Inventors: Kyle Rowe, St. Petersburg, FL (US); Dylan Hoskins, St. Petersburg, FL (US); John Rogers, St. Petersburg, FL (US); Jonathan Miller, St. Petersburg, FL (US); Numa Pailhol, St. Petersburg, FL (US)

(21) Appl. No.: 19/056,227

(22) Filed: Feb. 18, 2025

Related U.S. Application Data
(60) Provisional application No. 63/555,218, filed on Feb. 19, 2024.

(51) Int. Cl. B29C 64/106; B29C 64/188; B29C 64/30; B29L 31/44; B33Y 10/00; B33Y 40/20; B33Y 80/00

(52) U.S. Cl. CPC B29C 64/106; B29C 64/188; B29C 64/30; B33Y 10/00; B33Y 40/20; B33Y 80/00; B29L 2031/44

(57) ABSTRACT

A three-dimensional (3D) printed multi-component structure includes a first component and a second component. The first component has a first surface and a second surface opposite the first surface. The first component is formed to define a channel that extends into the first surface toward the second surface. The second component has an outer edge, a mating edge configured to mate with the channel of the first component to couple the first component to the second component, and a body extending between the outer edge and the mating edge.

### CROSS REFERENCE TO RELATED APPLICATIONS

This application claims priority to and the benefit of U.S. Provisional Patent Application No. 63/555,218, filed 19 Feb. 2024, the disclosure of which is now expressly incorporated herein by reference.

### FIELD OF THE DISCLOSURE

The present disclosure relates generally to furniture, and more specifically to 3D printed furniture and methods of the making the same.

### BACKGROUND

Disposing of some objects, such as furniture or décor, may be difficult. Furniture waste is becoming increasingly problematic as furniture is generally made of multiple different materials, many of which are difficult to recycle. Further, taking apart furniture to process each type of material separately is time-consuming and expensive.

Three-dimensional (3D) printing may be used to make three-dimensional objects. 3D printing is achieved using additive processes during which an object is created by laying down successive layers of material until the object is created. There remains interest in using 3D printing to reduce furniture waste.

### SUMMARY

The present disclosure may comprise one or more of the following features and combinations thereof.

A method of three-dimensional (3D) printing multi-component furniture may comprise providing a first furniture component having a first surface and a second surface opposite the first surface. The method may comprise removing material from the first surface of the first furniture component to form a channel in the first surface of the first furniture component. The method may comprise depositing at least one first layer of molten material in the channel to form a mating edge of a second furniture component having a contour of the channel. The method may comprise depositing at least one second layer of molten material onto the at least one first layer of molten material while the at least one first layer of molten material is molten to form a body of the second furniture component on the mating edge of the second furniture component. The method may comprise cooling the at least one first layer of molten material and the at least one second layer of molten material to cause the at least one first layer of molten material and the at least one second layer of molten material to solidify and form the second furniture component comprising the body and the mating edge having the contour that mates with the channel of the first furniture component.

In some embodiments, the channel of the first furniture component may be formed to include a base wall, a first sidewall extending upwardly from the base wall, and a second sidewall extending upwardly from the base wall. A width of the channel between the first sidewall and the second sidewall may remain constant or may increase as the first sidewall and the second sidewall extend upwardly from the base wall to the first surface of the first furniture component.

In some embodiments, a first angle may be formed between the first sidewall and the base wall. A second angle may be formed between the second sidewall and the base wall. The first angle and the second angle may each be 90 degrees.

In some embodiments, a first angle may be formed between the first sidewall and the base wall. A second angle may be formed between the second sidewall and the base wall. The first angle and the second angle may each be greater than 90 degrees. The method may further comprise, after cooling, separating the second furniture component from the first furniture component.

In some embodiments, the channel of the first furniture component may be formed to include a base wall, a first sidewall extending upwardly from the base wall, and a second sidewall extending upwardly from the base wall. A width of the channel between the first sidewall and the second sidewall may decrease as the first sidewall and the second sidewall extend upwardly from the base wall to the first surface of the first furniture component. A first angle may be formed between the first sidewall and the base wall. A second angle may be formed between the second sidewall and the base wall. The first angle and the second angle may each be less than 90 degrees.

In some embodiments, a first angle may be formed between the first sidewall and the base wall. A second angle may be formed between the second sidewall and the base wall. The first angle may be 90 degrees, and the second angle may be less than 90 degrees.

In some embodiments, providing a first furniture component may include 3D printing the first furniture component with at least one third layer of molten material. Removing material from the first surface of the first furniture component may include milling the material from the first surface of the first furniture component to form the channel in the first surface of the first furniture component.

According to another aspect of the present disclosure, a method of three-dimensional (3D) printing multi-component structures may comprise providing a first component having a first surface and a second surface opposite the first surface. The method may comprise forming a channel in the first surface. The method may comprise depositing a first layer of material in the channel. The method may comprise depositing a second layer of material onto the first layer of material while the first layer of material is molten. The method may comprise cooling the first layer of material and the second layer of material to cause the first layer of material and the second layer of material to form a second component having a contour of the channel.

In some embodiments, forming a channel in the first surface may include milling material from the first surface of the first component to form the channel in the first surface of the first component. The first layer of material may form a mating edge of the second component having the contour of the channel and the second layer of material may form a body of the second component. The mating edge of the second component may mate with the channel to couple the first component to the second component. The first component may be removably coupled with the second component.

In some embodiments, the channel of the first component may be formed to include a base wall, a first sidewall extending upwardly from the base wall, and a second sidewall extending upwardly from the base wall. A width of the channel between the first sidewall and the second sidewall may remain constant or may increase as the first sidewall and the second sidewall extend upwardly from the base wall to the first surface of the first component. The mating edge of the second component may be captured in the channel of the first component.

In some embodiments, the channel of the first component may be formed to include a base wall, a first sidewall extending upwardly from the base wall, and a second sidewall extending upwardly from the base wall. A width of the channel between the first sidewall and the second sidewall may decrease as the first sidewall and the second sidewall extend upwardly from the base wall to the first surface of the first component.

According to another aspect of the present disclosure, a three-dimensional (3D) printed multi-component structure may include a first component and a second component. The first component may have a first surface and a second surface opposite the first surface. The first component may be formed to define a channel that extends into the first surface toward the second surface. The second component may have an outer edge, a mating edge configured to mate with the channel of the first component to couple the first component to the second component, and a body extending between the outer edge and the mating edge. The mating edge may be formed to have a contour that matches a contour of the channel.

In some embodiments, the channel of the first component may be formed to include a base wall, a first sidewall extending upwardly from the base wall, and a second sidewall extending upwardly from the base wall. A width of the channel between the first sidewall and the second sidewall may remain constant or may increase as the first sidewall and the second sidewall extend upwardly from the base wall to the first surface of the first component.

### BRIEF DESCRIPTION OF THE DRAWINGS

The detailed description particularly refers to the accompanying figures in which:

FIG. 1 is a diagrammatic view of a method for three-dimensional (3D) printing a multi-component structure showing that the method includes (i) providing a first furniture component, (ii) milling the first furniture component to form a channel in the first furniture component, (iii) aligning a nozzle of a printer with the channel formed in the first furniture component, (iv) depositing at least one first layer of molten material into the channel to form a mating edge of a second furniture component, (v) depositing at least one second layer of molten material on the at least one first layer of molten material to form a body of the second furniture component, and (vi) cooling the molten material to form the second furniture component coupled with the first furniture component;

FIG. 2A is a diagrammatic view of a method for three-dimensional (3D) printing the multi-component structure showing that the method includes 3D printing the first furniture component prior to milling the channel in the first furniture component;

FIG. 2B is a continued diagrammatic view of the method of FIG. 2A;

FIG. 3A is a perspective view of the multi-component structure formed with the method of FIGS. 1-2B showing that the first furniture component is coupled with the second furniture component to form a multi-component table;

FIG. 3B is a sectional view of the multi-component table of FIG. 3A;

FIG. 4 is a perspective view of the first furniture component of FIG. 1 showing that the at least one first layer of molten material is deposited into the channel of the first furniture component to form the mating edge of the second furniture component that matches a contour of the channel;

FIG. 5 is a sectional view of a portion of the first furniture component of FIG. 1 showing that the channel has a generally constant width along a height of the channel so that the first furniture component and the second furniture component may be separated from one another without damage to the first furniture component, the second furniture component, or the mating edge of the second furniture component;

FIG. 6 is a sectional view of a portion of the first furniture component of FIG. 1 formed to include an alternative channel showing that the channel has an increasing width along a height of the channel so that the first furniture component and the second furniture component may be separated from one another without damage to the first furniture component, the second furniture component, or the mating edge;

FIG. 7A is a sectional view of a portion of a multi-component structure including the first furniture component and a second furniture component showing that at least one first layer of molten material is deposited into a free geometry channel of the first furniture component to form a hinge so that the second furniture component is in a first position relative to the first furniture component and free for movement relative to the first furniture component;

FIG. 7B is a sectional view of the multi-component structure of FIG. 7A showing that the second furniture component is in a second position after pivoting of the second furniture component relative to the first furniture component;

FIG. 8 is a sectional view of a portion of the first furniture component formed to include an alternative channel showing that the channel has a decreasing width along a height of the channel to cause a mating edge of the second furniture component to be captured in the channel of the first furniture component so that the first furniture component and the second furniture component may not be separated from one another without damage to the first furniture component, the second furniture component, or the mating edge;

FIG. 9 is a sectional view of a portion of the first furniture component formed to include an alternative channel showing that the channel has a decreasing width along a height of the channel to cause a mating edge of the second furniture component to be captured in the channel of the first furniture component so that the first furniture component and the second furniture component may not be separated from one another without damage to the first furniture component, the second furniture component, or the mating edge;

FIG. 10 is a sectional view of a portion of the first furniture component formed to include an alternative channel showing that the channel has a decreasing width along a height of the channel to cause a mating edge of the second furniture component to be captured in the channel of the first furniture component so that the first furniture component and the second furniture component may not be separated from one another without damage to the first furniture component, the second furniture component, or the mating edge;

FIG. 11A is a sectional view of a multi-component structure including the first furniture component and a second furniture component showing that at least one first layer of molten material is deposited into the captive geometry channel of the first furniture component to form a hinge so that the second furniture component is in a first position relative to the first furniture component and free for movement relative to the first furniture component;

FIG. 11B is a sectional view of the multi-component structure of FIG. 11A showing that the second furniture component is in a second position after pivoting of the second furniture component relative to the first furniture component;

FIG. 12 is a diagrammatic view of a method for forming a multi-component structure showing that the method includes (i) providing a first furniture component and a second furniture component, (ii) milling the first furniture component and the second furniture component to form a channel in the first furniture component and the second furniture component, (iii) aligning the channel formed in the first furniture component with the channel formed in the second furniture component, (iv) depositing molten material into the channel of the first furniture component and the second furniture component to form a mating edge that couples the first and second furniture components together and cooling the molten material to form the multi-component structure;

FIG. 13A is a top perspective view of the multi-component structure formed with the method of FIG. 12; and

FIG. 13B is a bottom perspective view of the multi-component structure formed with the method of FIG. 12.

### DETAILED DESCRIPTION

For the purposes of promoting an understanding of the principles of the disclosure, reference will now be made to a number of illustrative embodiments illustrated in the drawings and specific language will be used to describe the same.

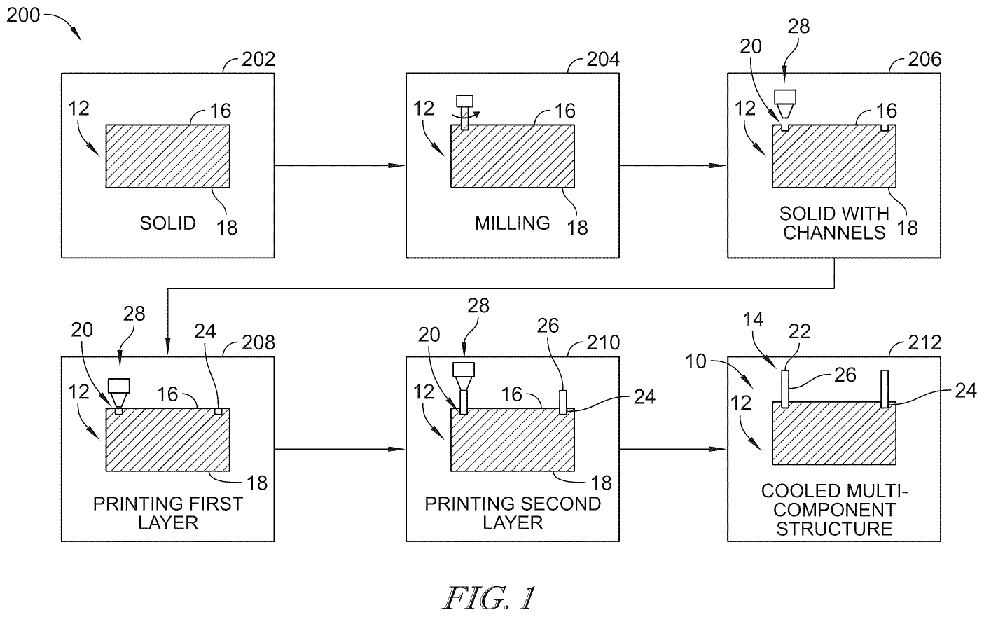

A three-dimensional (3D) printed multi-component structure 10 in accordance with the present disclosure includes a first furniture component 12 and a second furniture component 14, as shown in FIGS. 1-3A. The first furniture component 12 and the second furniture component 14 are coupled with one another without using adhesives and/or fasteners, such as interlaminar adhesion, glue, bolts, screws, rivets, nails, or other similar adhesives or fasteners. Instead, the first furniture component 12 and the second furniture component 14 are coupled with one another via a 3D printed mechanical connection. The absence of adhesives and/or fasteners allows for direct recycling and/or reuse of the first furniture component 12 and/or the second furniture component 14.

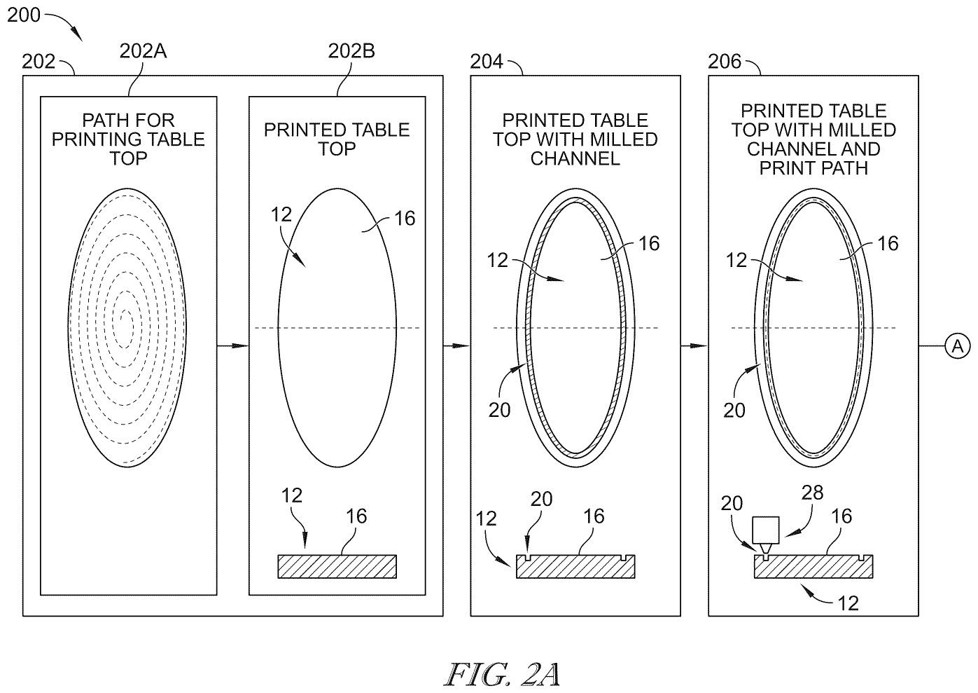

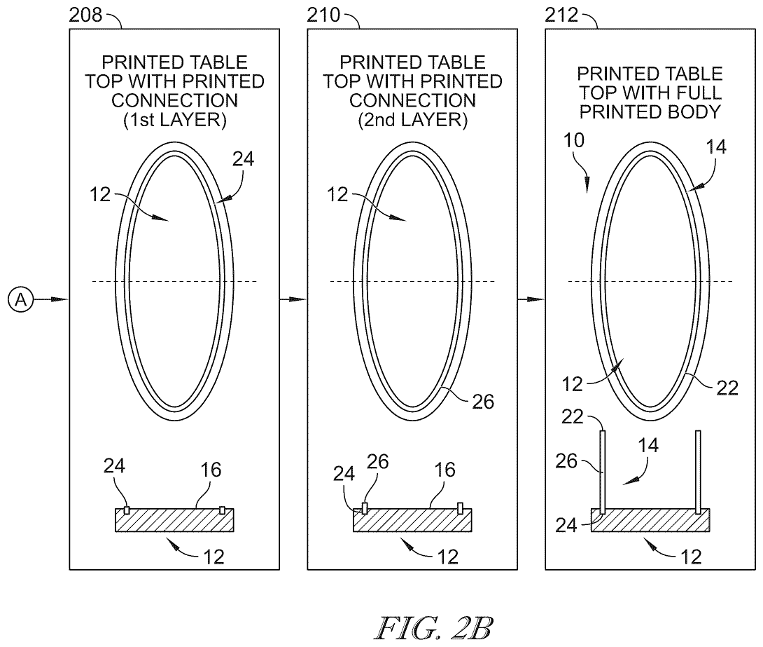

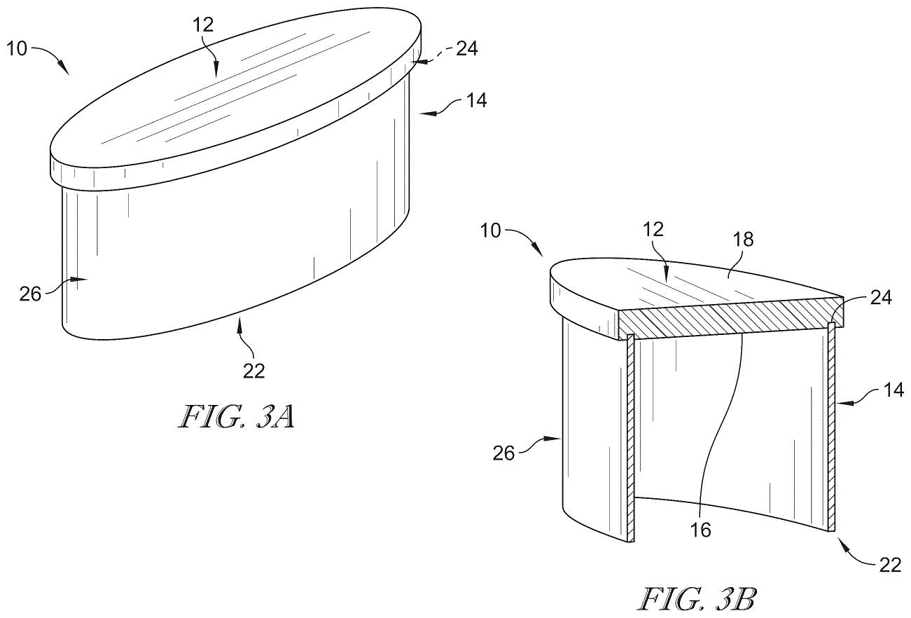

The first furniture component 12 includes a first surface 16 and a second surface 18 opposite the first surface 16, as shown in FIGS. 1, 3A, and 3B. The first furniture component 12 is formed to define a channel 20 that extends into the first surface 16 toward the second surface 18. In some embodiments, the first furniture component 12 is 3D printed, as shown in FIG. 2A. In some embodiments, the first furniture component 12 is not 3D printed. For example, the first furniture component 12 may include wood, metal, non-printed polymeric material, ceramic, stone, engineered materials, etc.

The second furniture component 14 includes an outer edge 22, a mating edge 24, and a body 26 extending between the outer edge 22 and the mating edge 24, as shown in FIGS. 1, 3A, and 3B. The mating edge 24 extends into and mates with the channel 20 of the first furniture component 12 to couple the first furniture component 12 with the second furniture component 14. Illustratively, the mating edge 24 forms the 3D printed mechanical connection. The mating edge 24 is formed to have a contour that matches a contour of the channel 20. The mating edge 24 allows for connection of the first furniture component 12 and the second furniture component 14 via friction and/or material fastening. In some embodiments, the second furniture component 14 is 3D printed. In some embodiments, the second furniture component 14 is not 3D printed. In some embodiments, the first furniture component 12 and the second furniture component 14 are formed of different materials. In some embodiments, the first furniture component 12 and the second furniture component 14 are formed of the same materials.

The second furniture component 14 is removably coupled with the first furniture component 12 in the illustrative embodiment. In some embodiments, the second furniture component 14 is coupled with the first furniture component 12 such that the components 12, 14 may not be separated without damaging one or more of the components 12, 14.

A method 200 of three-dimensional (3D) printing the multi-component structure 10 is shown in FIGS. 1, 2A, and 2B. FIGS. 2A and 2B shows a bottom view of the multi-component structure 10 in each step and a sectional view of the multi-component structure 10 through the dashed line in each step. In step 202, the first furniture component 12 is provided, for example, by 3D printing material or by providing a formed component of other material. In some embodiments, as shown in FIG. 2A, the step 202 of the method 200 includes step 202A of setting a print path for a nozzle 28 of a 3D printer to deposit at least one layer of molten material and step 202B of 3D printing the first furniture component 12. In some embodiments, the first furniture component 12 is not 3D printed and may be a wooden, metal, plastic, etc. material and made by traditional processes.

In step 204, the channel 20 is formed in the first surface 16 of the first furniture component 12. In the illustrative embodiment, the first furniture component 12 is fully cured or is in a rigid state. In other words, the channel 20 is formed in a rigid component and not made during an additive manufacturing process of forming the first furniture component. To form the channel 20, material from the first surface 16 is removed. In some embodiments, the channel 20 is formed by milling. In some embodiments, the channel 20 is formed by turning, drilling, grinding, cutting, lasering, or any other subtractive process. In some embodiments, the channel 20 is formed by an additive process of making the first furniture component 12. The channel 20 may by continuous, as shown in FIG. 2A. In other words, the channel 20 may form a circle, an oval, a rectangle, a square, or any other shape that is continuous.

In step 206, the nozzle 28 of the 3D printer is positioned above the first furniture component 12. The nozzle 28 is positioned at a nozzle height relative to the channel 20. The nozzle height may locate the nozzle 28 above the first surface 16, aligned with the first surface 16, or below the first surface 16 (i.e., in the channel 20). In step 206, a flow rate of the material being deposited into the channel 20 from the nozzle 28 is set. The nozzle height and the flow rate may be set based on a shape of the channel 20, the material being deposited into the channel 20, and/or a desired connection type between the first furniture component 12 and the second furniture component 14. To prepare a tighter fit between the components 12, 14, the flow rate may be increased so that more molten material is deposited into the channel 20 and/or the nozzle height may be decreased so that the nozzle 28 is closer to the channel 20. A print path for the nozzle 28 is also set in step 206. The print path is the path the nozzle 28 travels along the channel 20 to ensure the channel 20 is appropriately filled with the molten material.

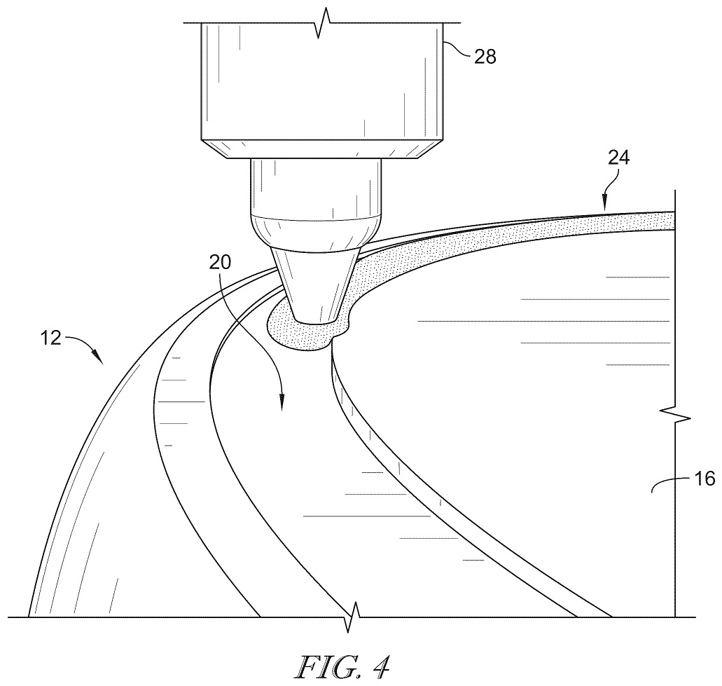

In step 208, at least one first layer of molten material is deposited into the channel 20 to form the mating edge 24 of the second furniture component 14, as shown in FIGS. 1, 2B, and 4. The nozzle 28 deposits the molten material into the channel 20 such that the channel 20 is partially or completely filled with the molten material. Depending on the shape of the channel 20, the material being deposited into the channel 20, and/or a desired connection type between the first furniture component 12 and the second furniture component 14, the molten material may be deposited into the channel 20 in a single pass or in multiple passes. For example, if a single pass is insufficient to fill the channel 20 with molten material, the molten material may be deposited into the channel 20 in multiple passes, as suggested in FIG. 4. Because the molten material is deposited into the channel 20 to form the mating edge 24 of the second furniture component 14, the mating edge 24 conforms to the shape of the channel 20 such that the mating edge 24 has a contour of the channel 20. The mating edge 24 conforming to the shape of the channel 20 may save production time as the mating edge 24 of the second furniture component 14 does not require machining to match the shape of the channel 20.

In step 210, at least one second layer of molten material is deposited onto the at least one first layer of molten material (i.e., the mating edge 24) while the at least one first layer of molten material is molten, as shown in FIGS. 1 and 2B. The at least one second layer of molten material forms the body 26 of the second furniture component 14. Additional layers of molten material may be deposited onto one another in step 210 until the desired shape of the second furniture component 14 is achieved. The body 26 is formed on the mating edge 24, and the outer edge 22 is formed on the body 26 opposite the mating edge 24. In step 212, the layers of molten material are cooled to cause the layers of molten material to solidify. In some embodiments, the molten material shrinks as the molten material cools in step 212. The shrinking of the molten material may prevent motion between the first furniture component 12 and the second furniture component 14.

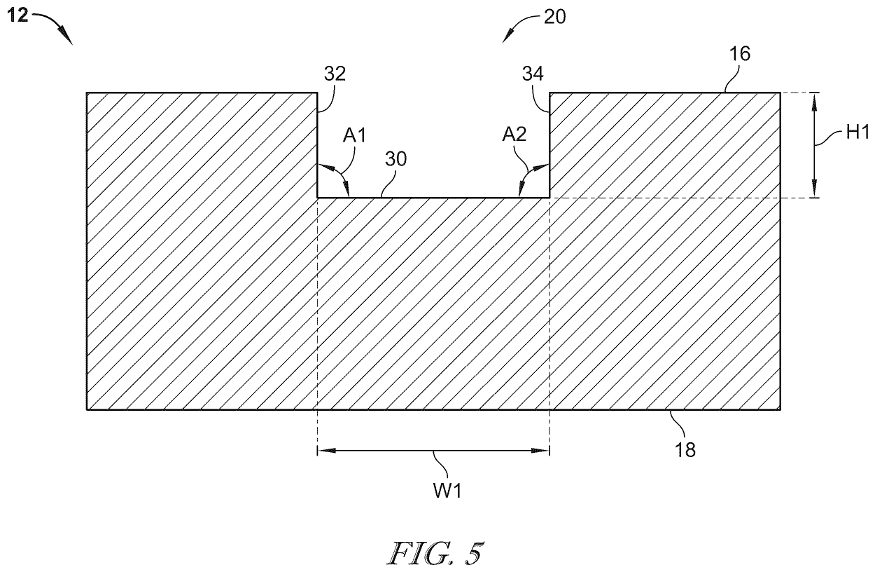

As shown in FIG. 5, the channel 20 is formed to include a base wall 30, a first sidewall 32, and a second sidewall 34. Each wall 30, 32, 34 may be substantially flat or straight. The first sidewall 32 extends upwardly from the base wall 30 to the first surface 16 of the first furniture component 12. The second sidewall 34 extends upwardly from the base wall 30 to the first surface 16 of the first furniture component 12. In some embodiments, the first sidewall 32 and the second sidewall 34 are substantially parallel to one another and perpendicular to the base wall 30. As shown in FIG. 5, a width W1 of the channel 20 between the first sidewall 32 and the second sidewall 34 remains constant as the first sidewall 32 and the second sidewall 34 extend upwardly from the base wall 30 to the first surface 16 of the first furniture component 12. In other words, the width W1 of the channel 20 may be defined as a function of a height H1 of the channel 20 (with the height H1 equal to zero at the base wall 30) where the width W1 does not decrease as the height H1 of the channel 20 increases. Instead, the width W1 remains constant as the height H1 of the channel 20 increases.

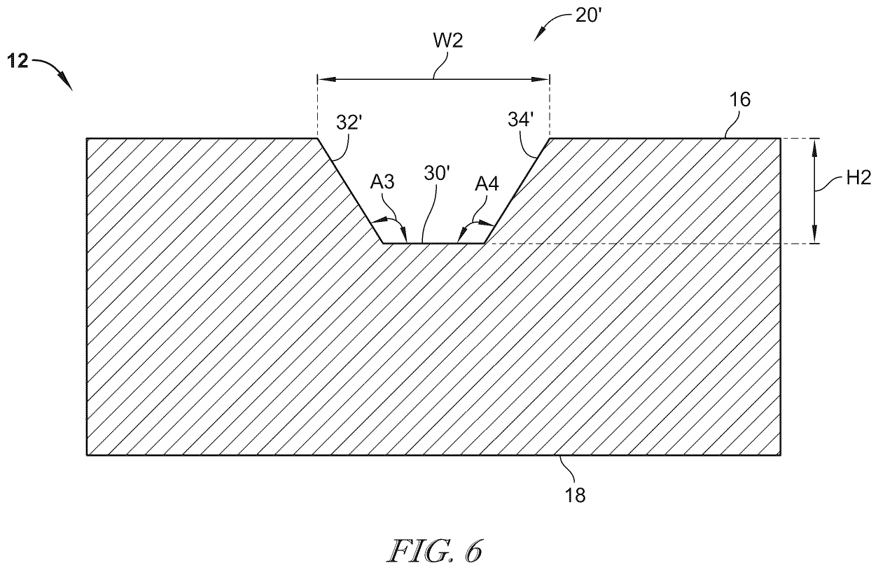

A first angle A1 is formed between the first sidewall 32 and the base wall 30, as shown in FIG. 5. A second angle A2 is formed between the second sidewall 34 and the base wall 30. In some embodiments, the first angle A1 and the second angle A2 are both about 90 degrees. The shape of the channel 20 allows the second furniture component 14 to be removably coupled with the first furniture component 12. In other words, the connection between the first furniture component 12 and the second furniture component 14 via the mating edge 24 is a temporary connection due to the free geometry of the channel 20. Free geometry channels, such as those shown in FIGS. 5 and 6, help to align and/or orient the first furniture component 12 and the second furniture component 14 relative to one another.

The shape of the channel 20 allows the first furniture component 12 and the second furniture component 14 to be disassembled and separated without damaging the first furniture component 12, the second furniture component 14, or the mating edge 24. Because the width W1 of the channel 20 does not decrease as the height H1 of the channel 20 increases, the mating edge 24 is free to be removed from the channel 20 without damage to the mating edge 24 or the components 12, 14.

In some embodiments, the first furniture component 12 is formed to include channel 20′, as shown in FIG. 6. The channel 20′ is formed to include a base wall 30′, a first sidewall 32′, and a second sidewall 34′. Each wall 30′, 32′, 34′ may be substantially flat or straight. The first sidewall 32′ extends upwardly from the base wall 30′ to the first surface 16 of the first furniture component 12. The second sidewall 34′ extends upwardly from the base wall 30′ to the first surface 16 of the first furniture component 12. As shown in FIG. 6, a width W2 of the channel 20′ between the first sidewall 32′ and the second sidewall 34′ increases as the first sidewall 32′ and the second sidewall 34′ extend upwardly from the base wall 30′ to the first surface 16 of the first furniture component 12. In other words, the width W2 may be defined as a function of a height H2 of the channel 20′ (with the height H2 equal to zero at the base wall 30′) where the width W2 does not decrease as the height H2 of the channel 20′ increases. Instead, the width W2 increases as the height H2 of the channel 20′ increases.

A third angle A3 is formed between the first sidewall 32′ and the base wall 30′, as shown in FIG. 6. A fourth angle A4 is formed between the second sidewall 34′ and the base wall 30′. In some embodiments, the third angle A3 and the fourth angle A4 are both greater than 90 degrees. In some embodiments, one of the third angle A3 and the fourth angle A4 is equal to 90 degrees and the other of the third angle A3 and the fourth angle A4 is greater than 90 degrees. The shape of the channel 20′ allows the second furniture component 14 to be removably coupled with the first furniture component 12. In other words, the connection between the first furniture component 12 and the second furniture component 14 via the mating edge 24 is a temporary connection due to the free geometry of the channel 20′. The shape of the channel 20′ allows the first furniture component 12 and the second furniture component 14 to be disassembled and separated without damaging the first furniture component 12, the second furniture component 14, or the mating edge 24.

With the channels 20, 20′, the first furniture component 12 and the second furniture component 14 may be separated from one another and reused or recycled. For example, the second furniture component 14 shown in FIG. 3A may be removed from the first furniture component 12, and a different first furniture component may be coupled with the second furniture component 14 (or vice versa), thereby allowing interchangeability of components 12, 14.

As one example, the components 12, 14 may be separated to change the first furniture component 12 between a fixturing surface for computer numerical control (CNC) operation and a printing surface. As another example, the components 12, 14 may be separated to change the first furniture component 12 to a different first furniture component having a different aesthetic (i.e., to change the look of the first furniture component 12). Additionally, for shipping purposes, the second furniture component 14 and the first furniture component 12 may be separated from one another for shipping, and the components 12, 14 may be assembled once the destination is reached. As another example, the second furniture component 14 and the first furniture component 12 may be used to create a removeable panel. The force needed to separate the components 12, 14 is a function of the coefficient of static friction between the materials of the first furniture component 12 and the materials of the mating edge 24 and the bonding that may be present. The force required to separate the components 12, 14 from one another may be at least partially dependent on the height H1, H2 of the channel 20, 20′ and the angle A1, A2, A3, A4 between the base wall 30, 30′ and the sidewalls 32, 34, 32′, 34′.

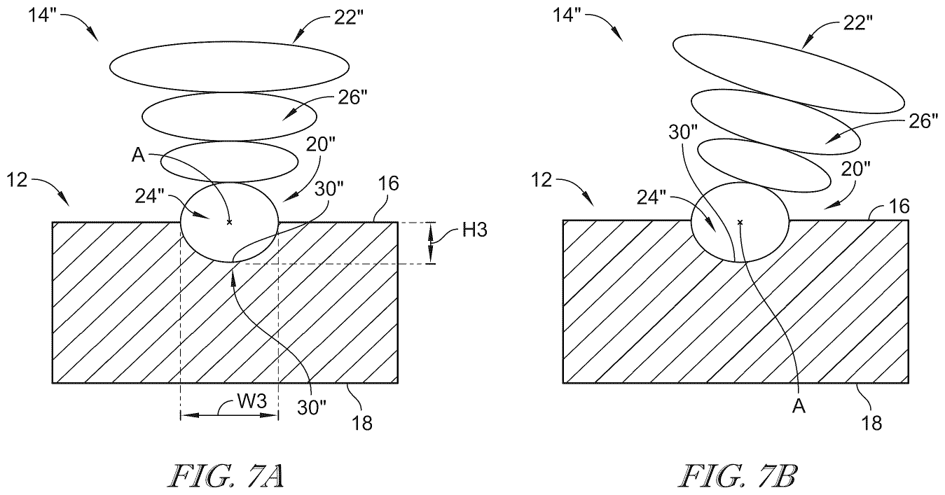

In some embodiments, the first furniture component 12 is formed to include channel 20″, as shown in FIGS. 7A and 7B. The channel 20″ has a semi-circular cross-sectional shape. A width W3 of the channel 20″ increases as the channel 20″ extends upwardly from a base 30″ of the channel 20″ to the first surface 16 of the first furniture component 12. In other words, the width W3 may be defined as a function of a height H3 of the channel 20″ (with the height H3 equal to zero at the base 30″) where the width W3 does not decrease as the height H3 of the channel 20″ increases. Instead, the width W3 increases as the height H3 increases. The shape of the channel 20″ is formed with a free geometry. The channel 20″ is illustratively formed as a linear channel 20″. In other words, instead of forming a continuous shape (like the channel 20 of FIG. 2A), the channel 20″ forms a linear shape having ends that do not connect with one another.

At least one first layer of molten material is deposited into the channel 20″ to form a hinge 24″ of a second furniture component 14″, as shown in FIGS. 7A and 7B. At least one second layer of molten material is deposited onto the at least one first layer of molten material (i.e., the hinge 24″) while the at least one first layer of molten material is molten. Additional layers of molten material may be deposited onto the at least one second layer of molten material. The at least one second layer of molten material forms the body 26″, and the outermost additional layer of molten material forms the outer edge 22″ of the second furniture component 14″.

Due to the shape of the channel 20″, the hinge 24″ is free for rotation within the channel 20″ about an axis A such that the second furniture component 14″ is movable relative to the first furniture component 12, as shown in FIGS. 7A and 7B. For example, as shown in FIG. 7A, the second furniture component 14″ is in a first position relative to the first furniture component 12. As shown in FIG. 7B, the second furniture component 14″ is pivotable relative to the first furniture component 12 about the axis A to assume a second position. To pivot the second furniture component 14″, the hinge 24″ rotates within the channel 20″. Additional rotation of the second furniture component 14″ will be blocked by the first furniture component 12 due to engagement of the body 26″ of the second furniture component 14″ with the first surface 16 of the first furniture component 12.

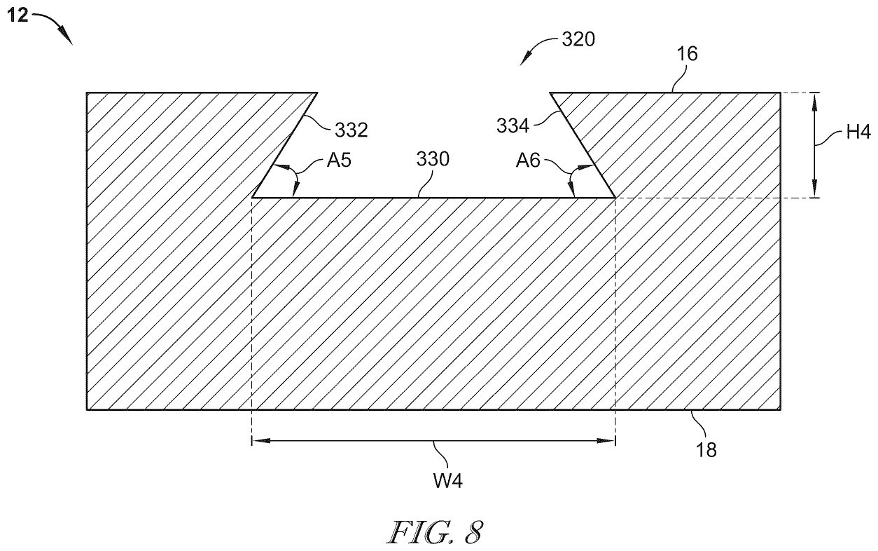

As shown in FIG. 8, in some embodiments, the first furniture component 12 is formed to include an alternative channel 320. The channel 320 includes a base wall 330, a first sidewall 332, and a second sidewall 334. Each wall 330, 332, 334 may be substantially flat or straight. The first sidewall 332 extends upwardly from the base wall 330 to the first surface 16 of the first furniture component 12. The second sidewall 334 extends upwardly from the base wall 330 to the first surface 16 of the first furniture component 12. As shown in FIG. 8, a width W4 of the channel 320 between the first sidewall 332 and the second sidewall 334 decreases as the first sidewall 332 and the second sidewall 334 extend upwardly from the base wall 330 to the first surface 16 of the first furniture component 12. In other words, the width W4 may be defined as a function of a height H4 of the channel 320 (with the height H4 equal to zero at the base wall 330) where the width W4 decreases as the height H4 of the channel 320 increases.

A fifth angle A5 is formed between the first sidewall 332 and the base wall 330, as shown in FIG. 8. A sixth angle A6 is formed between the second sidewall 334 and the base wall 330. In some embodiments, the fifth angle A5 and the sixth angle A6 are both less than 90 degrees.

The shape of the channel 320 captures the mating edge 24 of the second furniture component 14 in the channel 320. In other words, the connection between the first furniture component 12 and the second furniture component 14 via the mating edge 24 is a permanent connection due to the captive geometry of the channel 320. The shape of the channel 320 allows the first furniture component 12 and the second furniture component 14 to be disassembled and/or separated only by damaging at least one of the first furniture component 12, the second furniture component 14, and the mating edge 24.

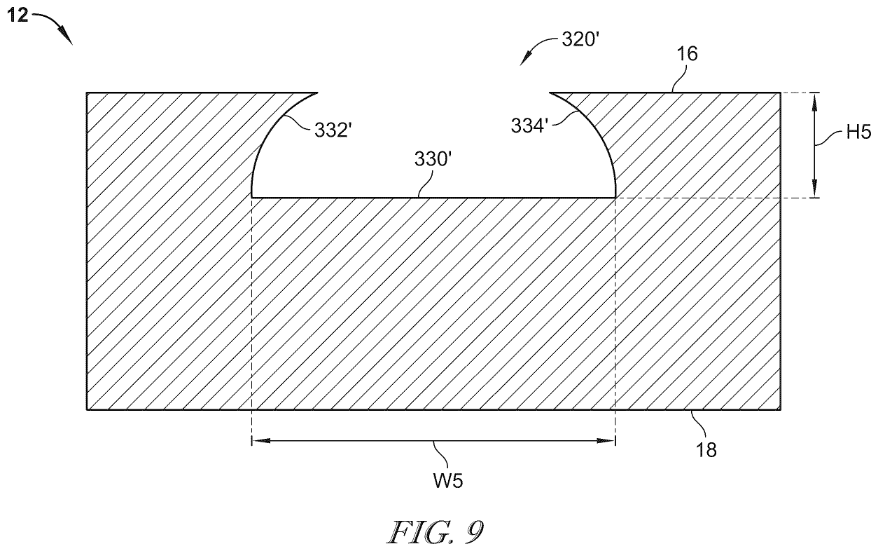

In some embodiments, the first furniture component 12 is formed to include channel 320′, as shown in FIG. 9. The channel 320′ is formed to include a base wall 330′, a first sidewall 332′, and a second sidewall 334′. Both sidewalls 332′, 234′ may be curved, while the base wall 330′ may be substantially flat or straight. The first sidewall 332′ extends upwardly from the base wall 330′ to the first surface 16 of the first furniture component 12. The second sidewall 334′ extends upwardly from the base wall 330′ to the first surface 16 of the first furniture component 12. As shown in FIG. 9, a width W5 of the channel 320′ between the first sidewall 332′ and the second sidewall 334′ decreases as the first sidewall 332′ and the second sidewall 334′ extend upwardly from the base wall 330′ to the first surface 16 of the first furniture component 12. In other words, the width W5 may be defined as a function of a height H5 of the channel 320′ (with the height H5 equal to zero at the base wall 330′) where the width W5 decreases as the height H5 of the channel 320′ increases. Each of the first sidewall 332′ and the second sidewall 334′ curve toward one another as the sidewalls 332′, 334′ extend upwardly away from the base wall 330′. In this way, an angle between each of the sidewalls 332′, 334′ and the base wall 330′ may be about 90 degrees.

The shape of the channel 320′ captures the mating edge 24 of the second furniture component 14 in the channel 320′. In other words, the connection between the first furniture component 12 and the second furniture component 14 via the mating edge 24 is a permanent connection due to the captive geometry of the channel 320′.

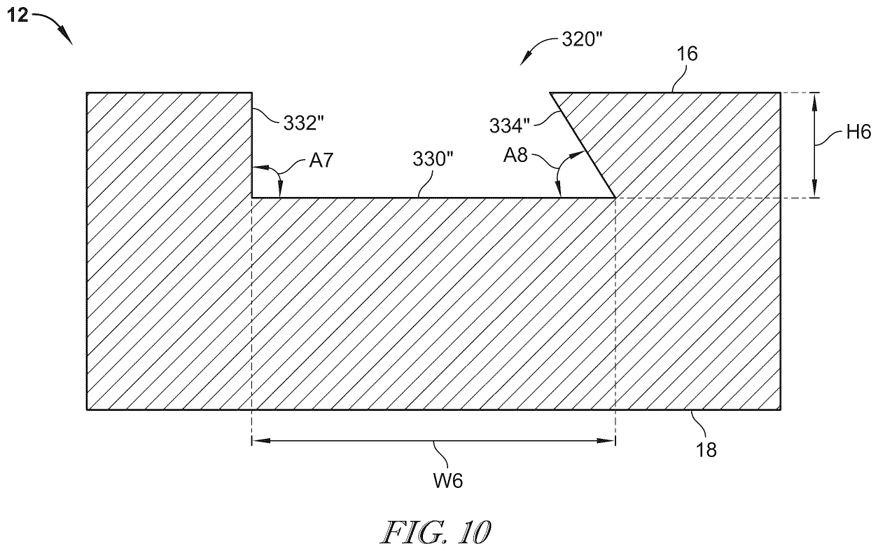

In some embodiments, the first furniture component 12 is formed to include a channel 320″, as shown in FIG. 10. The channel 320″ is formed to include a base wall 330″, a first sidewall 332″, and a second sidewall 334″. Each of the walls 330″, 332″, 334″ may be substantially flat or straight. The first sidewall 332″ extends upwardly from the base wall 330″ to the first surface 16 of the first furniture component 12. The second sidewall 334″ extends upwardly from the base wall 330″ to the first surface 16 of the first furniture component 12. As shown in FIG. 10, a width W6 of the channel 320″ between the first sidewall 332″ and the second sidewall 334″ decreases as the first sidewall 332″ and the second sidewall 334″ extend upwardly from the base wall 330″ to the first surface 16 of the first furniture component 12. In other words, the width W6 may be defined as a function of a height H6 of the channel 320″ (with the height H6 equal to zero at the base wall 330″) where the width W6 decreases as the height H6 of the channel 320″ increases. The first sidewall 332″ is perpendicular to the base wall 330″. A seventh angle A7 is formed between the first sidewall 332″ and the base wall 330″, as shown in FIG. 10. The seventh angle A7 may be about 90 degrees. An eighth angle A8 is formed between the second sidewall 334″ and the base wall 330″. In some embodiments, the eighth angle A8 is less than 90 degrees.

The shape of the channel 320″ captures the mating edge 24 of the second furniture component 14 in the channel 320″. In other words, the connection between the first furniture component 12 and the second furniture component 14 via the mating edge 24 is a permanent connection due to the captive geometry of the channel 320″.

With the channels 320, 320′, 320″, the first furniture component 12 and the second furniture component 14 may be permanently connected with one another. Though permanently connected, the first furniture component 12 and the second furniture component 14 may be disassembled and separated from one another by damaging at least one of the first furniture component 12, the second furniture component 14, and the mating edge 24. After separation, the undamaged pieces may be reused, and the damaged pieces may be recycled. For example, if only the mating edge 24 is damaged, the first furniture component 12 and the second furniture component 14 may be reused after the creation of a new mating edge to replace the damaged mating edge 24.

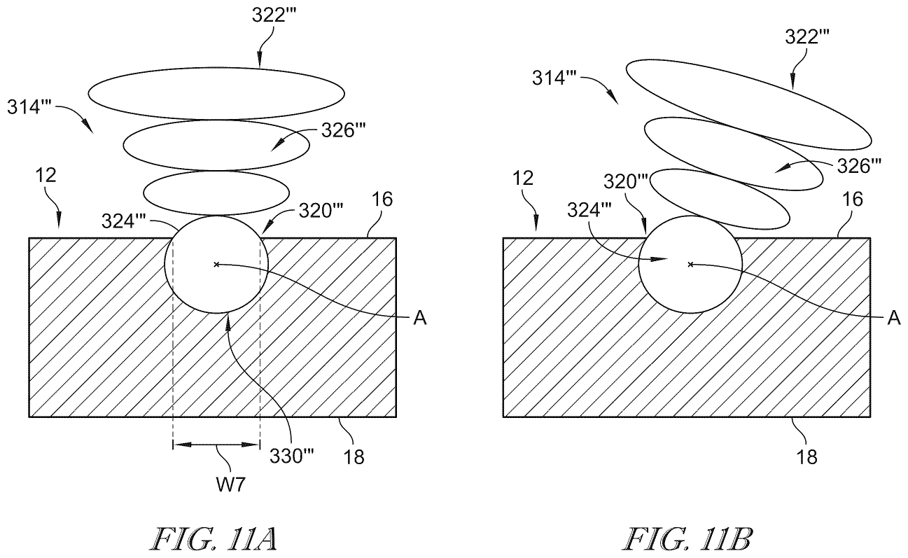

In some embodiments, the first furniture component 12 is formed to include a channel 320′″, as shown in FIGS. 11A and 11B. The channel 320′″ has a cross-sectional shape of more than half a circle. A width W7 of the channel 320′″ at the first surface 16 is smaller than a maximum width of the channel 320′″. The maximum width may be defined at a mid-way point of the channel 320′″ between a base 330′″ of the channel 320′″ and the first surface 16. The shape of the channel 320′″ is formed with a captive geometry. The channel 320′″ is illustratively formed as a linear channel 320′″. In other words, instead of forming a continuous shape (like the channel 20 of FIG. 2A), the channel 320′″ forms a linear shape having ends that do not connect with one another.

At least one first layer of molten material is deposited into the channel 320′″ to form a hinge 324′″ of a second furniture component 314′″, as shown in FIGS. 11A and 11B. At least one second layer of molten material is deposited onto the at least one first layer of molten material (i.e., the hinge 324′″) while the at least one first layer of molten material is molten. Additional layers of molten material may be deposited onto the at least one second layer of molten material. The at least one second layer of molten material forms the body 326′″, and the outermost additional layer of molten material forms the outer edge 322′″ of the second furniture component 314′″.

Due to the shape of the channel 320′″, the hinge 324′″ is free for rotation within the channel 320′″ such that the second furniture component 314′″ is movable relative to the first furniture component 12, as shown in FIGS. 11A and 11B. For example, as shown in FIG. 11A, the second component 314′″ is in a first position relative to the first component 12. As shown in FIG. 11B, the second furniture component 314′″ pivots relative to the first furniture component 12 about an axis A to assume a second position. To pivot the second furniture component 314′″, the hinge 324′″ rotates within the channel 320′″.

Any channel geometry that is not a free geometry is defined as a captive geometry. For example, the first sidewall 332, 332′, 332″ and/or the second sidewall 334, 334′, 334″ of the channel 320, 320′, 320″ may be formed to include a saw tooth pattern. The failure strength for the permanent connection between the components 12, 14 is the lowest material strength between the material of the first furniture component 12 and the material of the mating edge 24, accounting for stress concentrations.

The creation of the permanent connection between the components 12, 14 may be useful for combining the components 12, 14 into a permanent multi-component structure 10 that does not have a need for separation. For example, the permanent connection may be used to couple a foot to a planter or may be used to combine multiple components into a permanent assembly. As another example, the permanent connection may be used to permanently attach a tabletop to a base. As another example, the permanent connection may be used to permanently attach two pieces of a wooden desk together. As another example, the permanent connection may be used to create designated failure points. As another example, the permanent connection may be used to create a hinge using a circular channel.

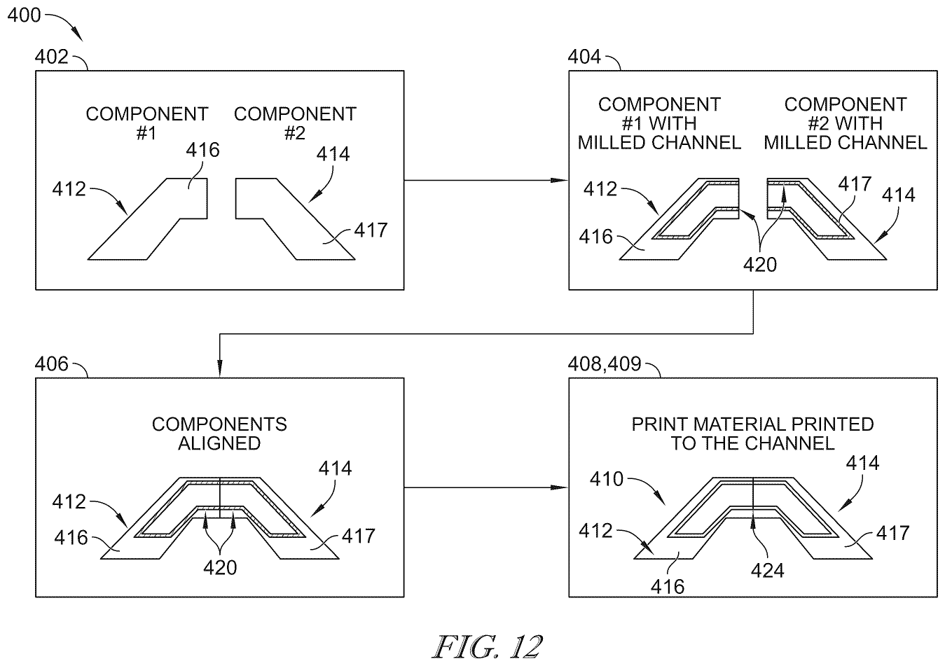

An alternative method 400 of forming a multi-component structure 410 is shown in FIG. 12. In step 402, a first furniture component 412 and a second furniture component 414 are provided. The first furniture component 412 and the second furniture component 414 are illustratively not 3D printed; however, the first furniture component 412 and the second furniture component 414 are coupled together via 3D printing. In step 404, a channel 420 is formed in a first surface 416 of the first furniture component 412 and a first surface 417 of the second furniture component 414. To form the channel 420, material from the first surfaces 416, 417 is removed. In some embodiments, the channels 420 are formed via milling. In step 406, the channels 420 of each component 412, 414 are aligned and a print path for the nozzle 28 is set.

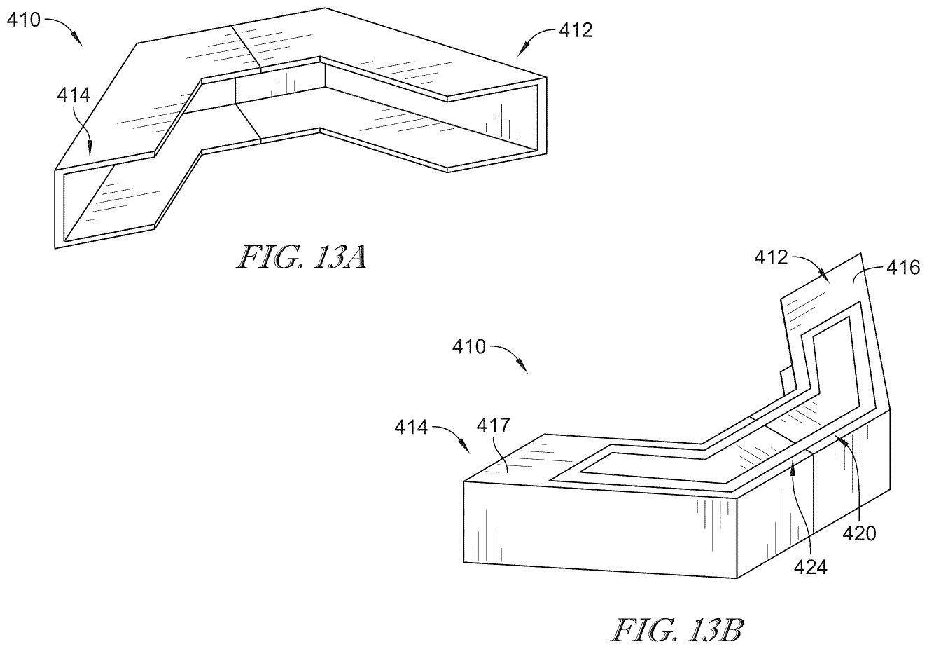

In step 408, at least one first layer of molten material is deposited into the channel 420 to form a mating edge 424 between the first furniture component 412 and the second furniture component 414. In step 409, the at least one first layer of molten material is cooled to cause the at least one first layer of molten material to solidify and fix the first furniture component 412 to the second furniture component 414, as shown in FIGS. 13A and 13B, to form the multi-component structure 410.

A printed mechanical connection is a connection between two or more components, where print material is used to join the two or more components permanently or temporarily. The printed mechanical connection is the dominant force with either friction and/or material fastening, where the load is transferred directly through contact with the other component or components. There may be some interlaminar adhesion, but it is not the primary mechanism for bonding. The printed mechanical connection, thus, is different from normal connections within a printed part where the connection is primarily interlaminar adhesion (i.e., the molecular chains of the printed polymer connecting one layer to the next). As the printed mechanical connection does not rely on the movement of polymer chains across the components being connected, as in a normal print, it allows components of other materials to be joined together to the printed component without the use of adhesive or other fasteners and for the connection of two printed parts where the connection would not reach a temperature allowing for polymer chain movements to create a bond.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A method of three-dimensional (3D) printing multi-component furniture, the method comprising
providing a first furniture component having a first surface and a second surface opposite the first surface,
removing material from the first surface of the first furniture component to form a channel in the first surface of the first furniture component,
depositing at least one first layer of molten material in the channel to form a mating edge of a second furniture component having a contour of the channel,
depositing at least one second layer of molten material onto the at least one first layer of molten material while the at least one first layer of molten material is molten to form a body of the second furniture component on the mating edge of the second furniture component, and
cooling the at least one first layer of molten material and the at least one second layer of molten material to cause the at least one first layer of molten material and the at least one second layer of molten material to solidify and form the second furniture component comprising the body and the mating edge having the contour that mates with the channel of the first furniture component.

2. The method of claim 1, wherein the channel of the first furniture component is formed to include a base wall, a first sidewall extending upwardly from the base wall, and a second sidewall extending upwardly from the base wall, and wherein a width of the channel between the first sidewall and the second sidewall remains constant or increases as the first sidewall and the second sidewall extend upwardly from the base wall to the first surface of the first furniture component.

3. The method of claim 2, wherein a first angle is formed between the first sidewall and the base wall, a second angle is formed between the second sidewall and the base wall, and the first angle and the second angle are each 90 degrees.

4. The method of claim 2, wherein a first angle is formed between the first sidewall and the base wall, a second angle is formed between the second sidewall and the base wall, and the first angle and the second angle are each greater than 90 degrees.

5. The method of claim 2, further comprising, after cooling, separating the second furniture component from the first furniture component.

6. The method of claim 1, wherein the channel of the first furniture component is formed to include a base wall, a first sidewall extending upwardly from the base wall, and a second sidewall extending upwardly from the base wall, and wherein a width of the channel between the first sidewall and the second sidewall decreases as the first sidewall and the second sidewall extend upwardly from the base wall to the first surface of the first furniture component.

7. The method of claim 6, wherein a first angle is formed between the first sidewall and the base wall, a second angle is formed between the second sidewall and the base wall, and the first angle and the second angle are each less than 90 degrees.

8. The method of claim 6, wherein a first angle is formed between the first sidewall and the base wall, a second angle is formed between the second sidewall and the base wall, the first angle is 90 degrees, and the second angle is less than 90 degrees.

9. The method of claim 1, wherein providing a first furniture component includes 3D printing the first furniture component with at least one third layer of molten material.

10. The method of claim 1, wherein removing material from the first surface of the first furniture component includes milling the material from the first surface of the first furniture component to form the channel in the first surface of the first furniture component.

11. A method of three-dimensional (3D) printing multi-component structures, the method comprising
providing a first component having a first surface and a second surface opposite the first surface,
forming a channel in the first surface,
depositing a first layer of material in the channel,
depositing a second layer of material onto the first layer of material while the first layer of material is molten, and
cooling the first layer of material and the second layer of material to cause the first layer of material and the second layer of material to form a second component having a contour of the channel.

12. The method of claim 11, wherein forming a channel in the first surface includes milling material from the first surface of the first component to form the channel in the first surface of the first component.

13. The method of claim 11, wherein the first layer of material forms a mating edge of the second component having the contour of the channel and the second layer of material forms a body of the second component.

14. The method of claim 13, wherein the mating edge of the second component mates with the channel to couple the first component to the second component.

15. The method of claim 14, wherein the first component is removably coupled with the second component.

16. The method of claim 15, wherein the channel of the first component is formed to include a base wall, a first sidewall extending upwardly from the base wall, and a second sidewall extending upwardly from the base wall, and wherein a width of the channel between the first sidewall and the second sidewall remains constant or increases as the first sidewall and the second sidewall extend upwardly from the base wall to the first surface of the first component.

17. The method of claim 14, wherein the mating edge of the second component is captured in the channel of the first component.

18. The method of claim 17, wherein the channel of the first component is formed to include a base wall, a first sidewall extending upwardly from the base wall, and a second sidewall extending upwardly from the base wall, and wherein a width of the channel between the first sidewall and the second sidewall decreases as the first sidewall and the second sidewall extend upwardly from the base wall to the first surface of the first component.

19. A three-dimensional (3D) printed multi-component structure, the multi-component structure comprising
a first component having a first surface and a second surface opposite the first surface, the first component being formed to define a channel that extends into the first surface toward the second surface, and
a second component having an outer edge, a mating edge configured to mate with the channel of the first component to couple the first component to the second component, and a body extending between the outer edge and the mating edge, the mating edge being formed to have a contour that matches a contour of the channel.

20. The multi-component structure of claim 19, wherein the channel of the first component is formed to include a base wall, a first sidewall extending upwardly from the base wall, and a second sidewall extending upwardly from the base wall, and wherein a width of the channel between the first sidewall and the second sidewall remains constant or increases as the first sidewall and the second sidewall extend upwardly from the base wall to the first surface of the first component.
